(19) United States
(12) Patent Application Publication
(10) Pub. No.: US 2015/0227279 A1
(43) Pub. Date: Aug. 13, 2015

(54) VARIABLE HORIZONTAL SCROLLING

(71) Applicant: Microsoft Corporation, Redmond, WA (US)

(72) Inventors: George Bielitz, Sammamish, WA (US); John Howard Cook, III, Fort Collins, CO (US); Ingrid Lin, Seattle, WA (US)

(73) Assignee: Microsoft Corporation, Redmond, WA (US)

(21) Appl. No.: 14/178,855

(22) Filed: Feb. 12, 2014

(51) Int. Cl. G06F 3/0485

(52) U.S. Cl. CPC G06F 3/0485

(57) ABSTRACT

Embodiments are disclosed that relate to human interface devices configured to enable variable horizontal scrolling. For example, one disclosed embodiment provides a human interface device comprising a horizontal scrolling control, and one or more sensors configured to sense movement of the horizontal scrolling control and provide output that varies depending upon a value of a variable characteristic of the movement. The human interface device further comprises a controller configured to output horizontal scrolling reports having two or more different possible values for each direction of horizontal scrolling based upon the output of the one or more sensors.

### BACKGROUND

Human interface devices, such as computer mice, keyboards, keypads, and the like, may use devices such as scroll wheels with optical tracking to navigate a computer user interface. A scroll wheel may include a wheel that is rotatable by a user's finger, and an optical sensor or other suitable sensor that can detect rotation of the wheel. Sensor information may then be processed into data for reporting to a computing device, e.g. in the form of a vertical scrolling report. Further, some scroll wheels may be tillable to allow for horizontal scrolling functionality.

### SUMMARY

Embodiments are disclosed that relate to human interface devices configured to enable variable horizontal scrolling. For example, one disclosed embodiment provides a human interface device configured to provide outputs to a computing device. The human interface device comprises a movable horizontal scrolling control, and one or more sensors configured to sense movement of the horizontal scrolling control and provide, for each direction of movement of the horizontal scrolling control, output that varies depending upon a value of a variable characteristic of the movement. The human interface device further comprises a controller configured to output horizontal scrolling reports having two or more different possible values for each direction of horizontal scrolling based upon the output of the one or more sensors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of a human interface device configured to enable variable horizontal scrolling in accordance with an embodiment of the present disclosure.

FIG. 2 shows a block diagram of the components of a human interface device in accordance with an embodiment of the present disclosure.

FIG. 3 schematically shows a perspective view of the components of a human interface device in accordance with an embodiment of the present disclosure.

FIG. 4 schematically illustrates the amplification of rotational motion in a human interface device in accordance with an embodiment of the present disclosure.

FIG. 5 shows an electrical schematic diagram of a human interface device in accordance with an embodiment of the present disclosure.

FIG. 6 schematically illustrates mapping of tilt angles to horizontal scrolling speeds in accordance with an embodiment of the present disclosure.

FIG. 7 shows a flowchart illustrating a method of generating horizontal scrolling reports in accordance with an embodiment of the present disclosure.

FIG. 8 shows a block diagram of a computing device in accordance with an embodiment of the present disclosure.

### DETAILED DESCRIPTION

As described above, a variety of human interface devices (HIDs) may be used to supply input to a computing device. One example of an HID is a computer mouse, which may be used to control the two-dimensional position of a cursor displayed in a graphical user interface (GUI) by the computing device. Some mice may include a mechanism such as a scroll wheel to enable content displayed in a GUI to be vertically traversed. Further, some mice may include a mechanism such as a tiltable scroll wheel to enable content to be horizontally traversed. However, such mice may merely enable horizontal scrolling to be turned on or off in a binary manner, and may not allow users to adjust the speed or distance of traversal in a smooth manner.

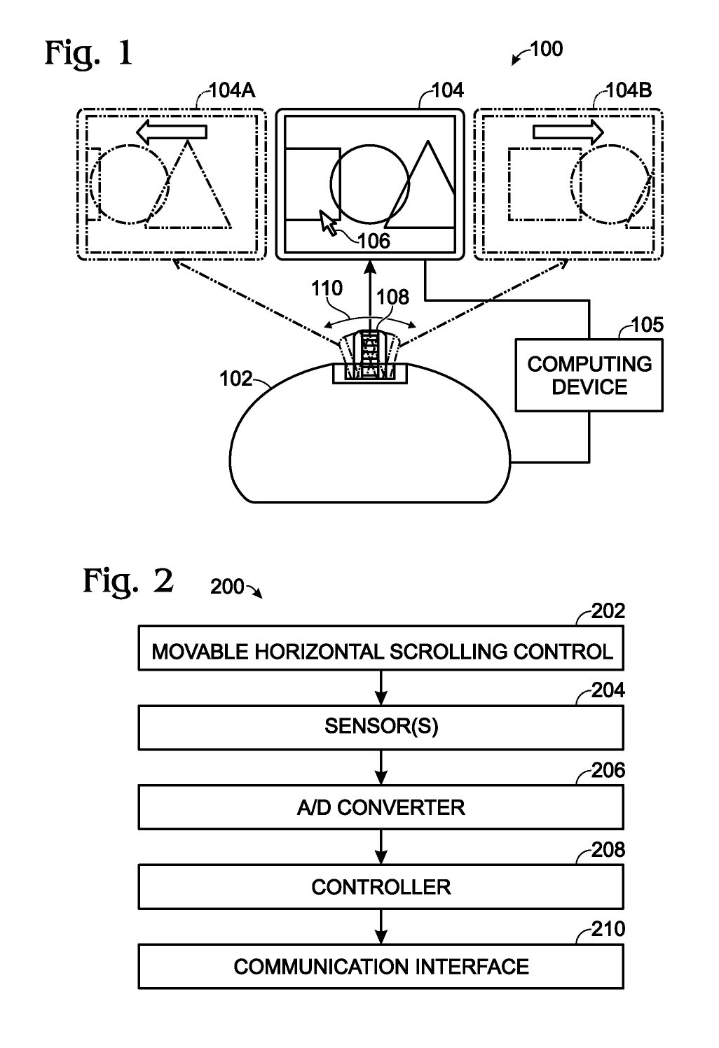

Accordingly, embodiments are disclosed that relate to HIDs configured to enable variable horizontal scrolling. This may allow users to horizontally traverse content through a plurality of speeds and distances in a smooth and controllable manner FIG. 1 shows an example environment 100 including a human interface device (HID) 102 configured to enable variable horizontal scrolling. HID 102 may be used to horizontally traverse visual content presented by a display device 104, for example. While shown in the form of a computer mouse, HID 102 may take the form of other input devices, including but not limited to a remote control, game controller, keyboard, etc.

A computing device 105 may control the output of display device 104, and may adjust at least a portion of such output based on input received from HID 102 via any suitable wired or wireless connection (e.g., universal serial bus (USB), Bluetooth, etc.). For example, the two-dimensional position of a cursor 106 displayed by display device 104 may be adjusted based on input received from HID 102. Various suitable tracking technologies may be used to generate two-dimensional input, such as an optical tracking mechanism or mechanical track ball, for example.

In addition to horizontal scrolling, HID 102 may enable other functionality. For example, a scroll wheel 108 may enable content presented by display device 104 to be vertically traversed via rotation. HID 102 may also include one or more buttons (not shown), which, when depressed, may allow elements in a GUI presented by display device 104 to be selected and/or activated, for example.

FIG. 1 also illustrates an example of horizontal scrolling utilizing HID 102. As shown, the scroll wheel 108 may be tilted from side-to-side (represented in the figure by arrows 110), causing horizontal scrolling of visual content presented by display device 104. Windows 104A and 104B particularly illustrate how visual content presented by display device 104 may be horizontally traversed in two directions.

FIG. 2 shows a block diagram of the components of an HID 200 configured to facilitate horizontal scrolling, such as HID 102. It will be appreciated that the components shown in FIG. 2 are not intended to be limiting, and that various additions, modifications, and subtractions are possible without departing from the scope of this disclosure.

The HID 200 includes a horizontal scrolling control 202 configured to enable horizontal scrolling. Control 202 may take various suitable forms including that of a control that has two independent directions of motion in which it may tilt. In some embodiments, control 202 may take the form of a control that enables tilt motion in addition to other types of motion. For example, control 202 may represent scroll wheel 108 and enable both tilt motion and rotational motion, and thus both horizontal and vertical scrolling. Alternatively, control 202 may represent a mechanical device that enables tilt motion in two or more axes, rotational motion, and/or motion or actuation in a Z-axis with respect to the computing device.

The HID 200 further includes one or more sensors 204 communicatively coupled to control 202 and configured to sense movement of control 202. The one or more sensors 204 may provide output that varies depending upon a value (e.g., magnitude) of a variable characteristic of the movement of control 202. Any suitable variable characteristics may be used, including but not limited to distance (e.g., the degree to which control 202 is displaced relative to a resting position) and the rate of change of such distance (e.g., speed).

The one or more sensors 204 may include various suitable types of sensors, including but not limited to a potentiometer, Hall Effect sensor, pressure sensor, force sensor, and one or more digital switches. An example HID using a potentiometer is described below with reference to FIG. 3.

The HID 200 further includes an analog-to-digital (A/D) converter 206 communicatively coupled to the one or more sensors 204 and configured to convert analog signals from the one or more sensors into digital values. For embodiments in which a potentiometer is used to detect and measure tilt of control 202, A/D converter 206 may read the center tap voltage of the potentiometer at a suitable frequency to produce a digital output. As non-limiting examples, converter 206 may sample output from the one or more sensors 204 every 16 ms, and output values in a range from 0 to 255.

The HID 200 further includes a controller 208 communicatively coupled to A/D converter 206 and configured to receive digital values from the converter and output horizontal scrolling reports based upon the digital values. Horizontal scrolling reports may include data indicating the occurrence and nature of horizontal scrolling—for example, the reports may indicate the location (e.g., position) and change in location (e.g., speed) of control 202. In some embodiments, horizontal scrolling reports may include two or more different possible values for each direction of horizontal scrolling based upon the output of the one or more sensors 204. It will be appreciated that controller 208 may output any other types of scrolling reports that indicate any suitable information, including but not limited to a state or states of other components (e.g., button depression, rotation of a vertical scrolling control, etc.).

The HID 200 also includes a communication interface 210 communicatively coupled to controller 208 and configured to output information to a computing device communicatively coupled with the HID. Interface 210 may include various suitable communication technologies, such as a wired or wireless interface (e.g. a universal serial bus (USB) interface and/or Bluetooth interface) to allow communication with a computing device receiving outputs from the HID.

FIG. 3 schematically shows a perspective view of the components 300 of an embodiment of an HID 300 configured to facilitate horizontal scrolling. The illustrated components may be incorporated into HID 102 and/or HID 200, for example. HID 300 includes a horizontal scrolling control 302, shown in this example as a tillable scroll wheel operable to enable horizontal as well as vertical scrolling. Control 302 is coupled to a moment arm 304, shown in the figure as a shaft, which is in turn coupled to a lever 306. Lever 306 is coupled to a gear mechanism 308, which is in turn connected to a potentiometer 310. Gear mechanism 308 may connect to a portion (e.g., shaft) of potentiometer 310 such that rotation in the gear mechanism, caused by tilting of control 302, is translated to motion in the potentiometer, causing changes in the resistance of the potentiometer that may be detected via a voltage at a center tap of the potentiometer. This voltage may be digitized and used to generate horizontal scrolling reports. Such potentiometer motion may be rotation of a tap in the form of a wiper (not shown), for example. It will be appreciated that potentiometer 310 is described for the purpose of example, and that any other suitable type of sensor or sensors may be used to sense tilt of control 302.

It may be desirable to utilize a relatively large amount of the operational range of the potentiometer (e.g., the range of angles through which the potentiometer wiper may rotate) for resolution and sensitivity. However, physical constraints (e.g., stop 312) of the HID 300 may impose a limited range of tilt motion on horizontal scrolling control 302 and thus the operational range of potentiometer 310. As such, lever 306 and gear mechanism 308 may help to mitigate this issue by amplifying tilt motion in control 302 so that a relatively larger operational range of potentiometer 310 may be utilized than in the absence of lever 306 and gear mechanism 308.

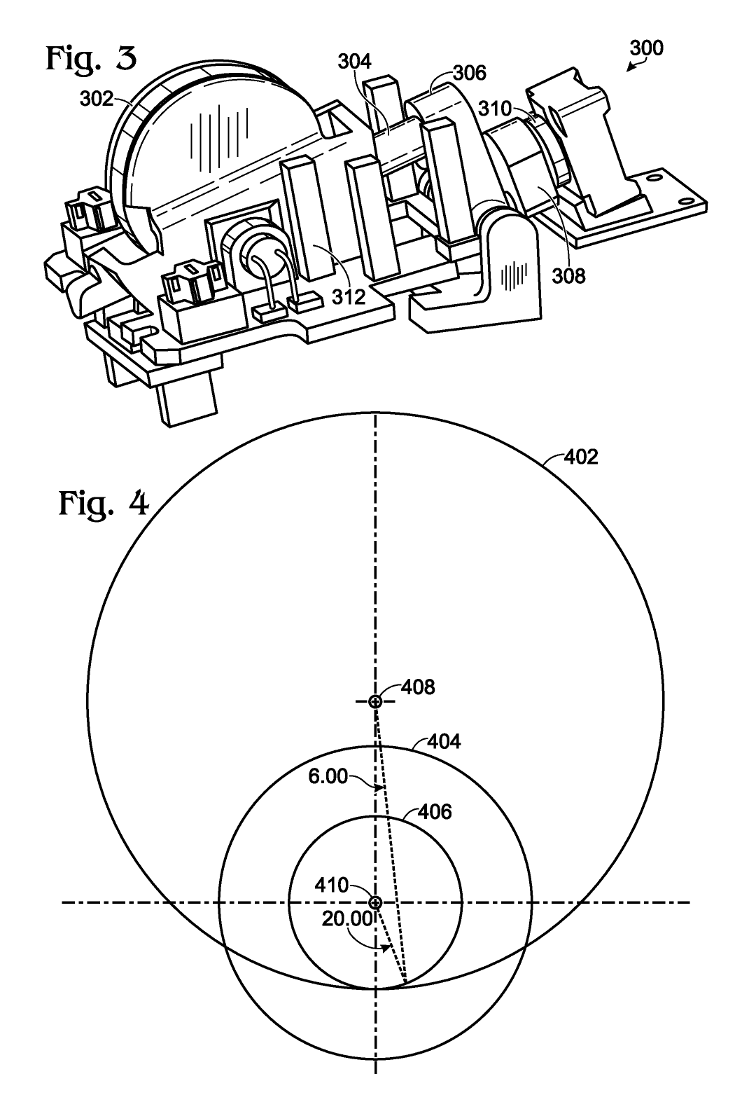

FIG. 4 illustrates the amplification of motion in horizontal scrolling control 302 by lever 306 and gear mechanism 308. Circles 402, 404, and 406 schematically represent the circles of rotation that would be traced out if scroll wheel 302, potentiometer 310, and gear mechanism 308, were rotated through 360°, respectively, and generally illustrate how rotation of scroll wheel 302 through a relatively smaller angle may cause rotation of the potentiometer 310 tap through a relatively larger angle. As shown, scroll wheel 302 rotates about a rotation axis 408 up to 6° for each direction (e.g., clockwise and counterclockwise). However, amplification of such rotation via lever 306 and gear mechanism 308 enables a 6° rotation of the pivot arm to cause a 20° rotation of potentiometer 310 in the corresponding direction about a rotation axis 410. Thus, the inclusion of lever 306 and gear mechanism 308 may enable the use of a wider range of motion of the potentiometer center tap than if the lever and/or gear mechanisms were omitted. This arrangement may advantageously permit a more substantial dynamic range of the potentiometer to be used.

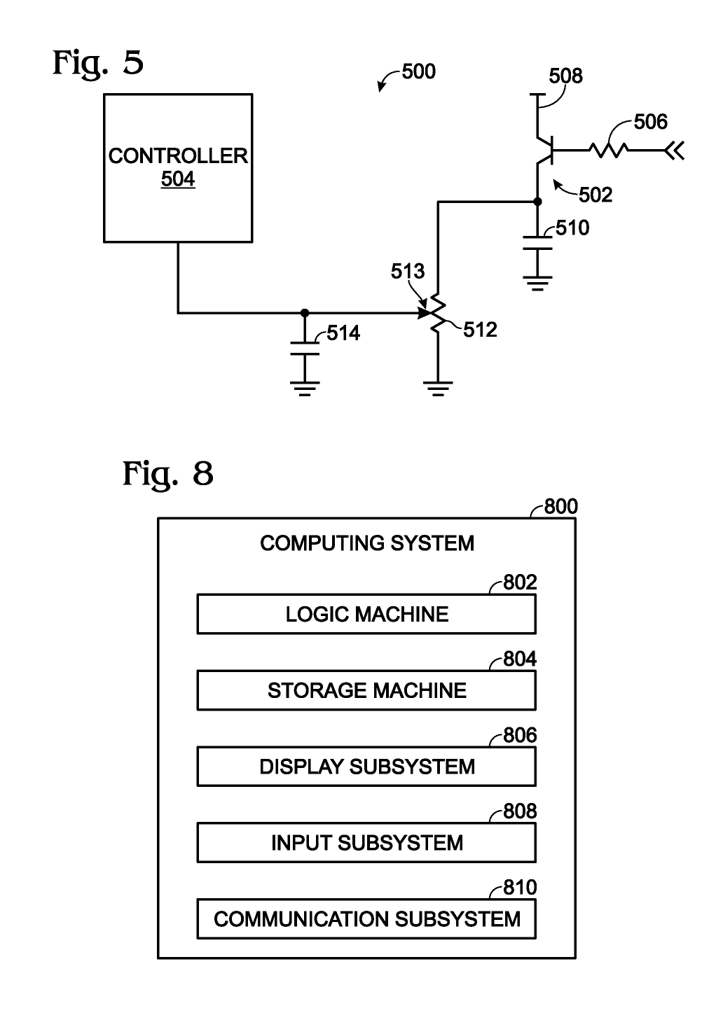

FIG. 5 shows an electrical schematic diagram of an HID 500 in accordance with an embodiment of the present disclosure. HID 500 may represent HID 102, for example. HID 500 includes a power switch circuit 502 configured to selectively supply current to a potentiometer 512. The depicted power switch circuit 502 includes a resistor 506, transistor 508 having a base coupled to an input voltage, and a capacitor 510 coupled to ground, but may take any other suitable form. Input voltage provided to resistor 506 to activate transistor 508 may be a switchable power control signal for HID 500.

The output of power switch circuit 502 is coupled to one terminal of potentiometer 512, and another terminal of potentiometer 512 is coupled to ground. Further, a tap 513 of potentiometer 512 is coupled to controller 504 and to a second capacitor 514, which is also coupled to ground. A capacitance of capacitor 514 may be selected to reduce noise in signals provided to controller 504 from potentiometer 512. Controller 504 may receive analog signals and convert the analog signals to digital signals for analysis, or a separate A/D converter (not shown) may be disposed between the potentiometer 512 and controller 504 in some embodiments. Controller 504 also may analyze the digital signals to produce a horizontal scrolling report or other suitable output.

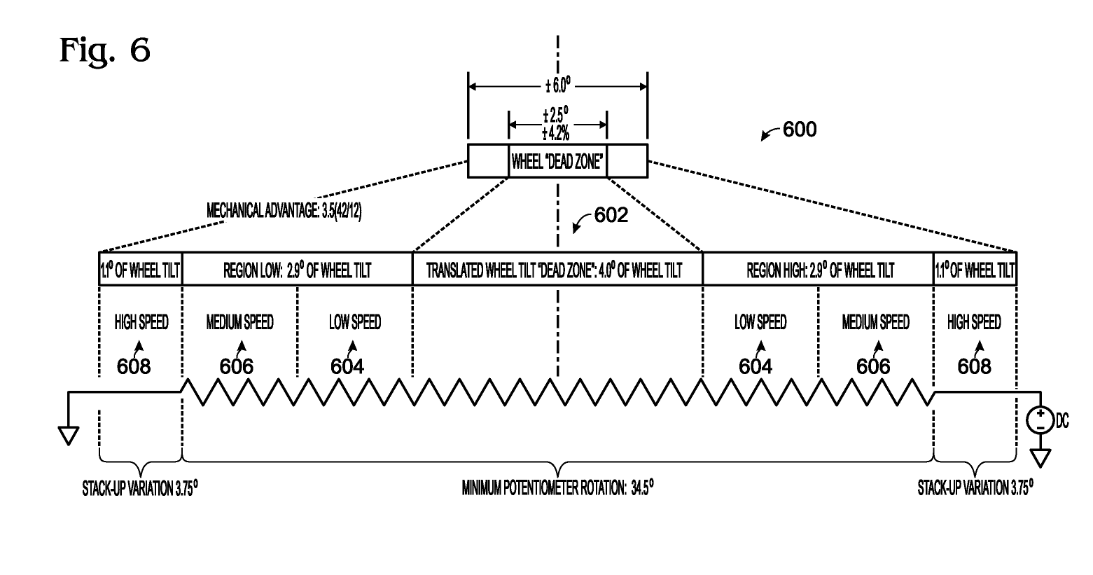

FIG. 6 schematically illustrates how different tilt angles of a horizontal scrolling control may be used to control different types of horizontal scrolling. More particularly, FIG. 6 shows a non-limiting example of how digitized output from one or more sensors (e.g., potentiometer 310) configured to sense a range of tilt positions may be mapped to different regions of a continuum 600 of horizontal scrolling speeds.

Continuum 600 includes at its center a zone 602 (titled “dead zone” in FIG. 6) in which tilt angles ranging from −2.5° to 2.5° are not mapped to any horizontal scrolling speed—in other words, these angles do not cause horizontal scrolling. A “dead zone” may advantageously provide a zone in which a user's inadvertent, relatively minor tilting movements or electrical noise are ignored and not interpreted as an intent to scroll. “Tilt angle” as used herein refers to the angle through which a tiltable horizontal scrolling control may be rotated, and may refer to the tile angle of HID 102 and/or moment arm 304, for example. Next, tilt angles greater than 2.5° in either direction (e.g. outside of the range of 2.5° to −2.5° are shown as prompting the generation of horizontal scrolling reports that may be used to control horizontal scrolling on a graphical user interface. For example, tilt angles between +/−2.5° and +/−3.67° in a low zone 604 may be mapped to horizontal scrolling at a relatively low speed, tilt angles between +/−3.67° and +/−4.83° in a medium zone 606 may be mapped to horizontal scrolling at a relatively moderate speed, and tilt angles between +/−4.83° and +/−6° in a high zone 608 may be mapped to horizontal scrolling at a relatively high speed.

It will be appreciated that the angles and zones described herein with reference to FIG. 6 are provided for the sake of illustration and are not intended to be limiting in any way. In general, digitized output from one or more sensors configured to sense tilt motion may be mapped to a virtually unlimited number of regions in a horizontal scrolling speed continuum. Moreover, selection of horizontal scrolling speeds may be based on change in location data in addition to location data. For example, a greater change in location value in a horizontal scrolling report may lead to a faster acceleration between scrolling speeds.

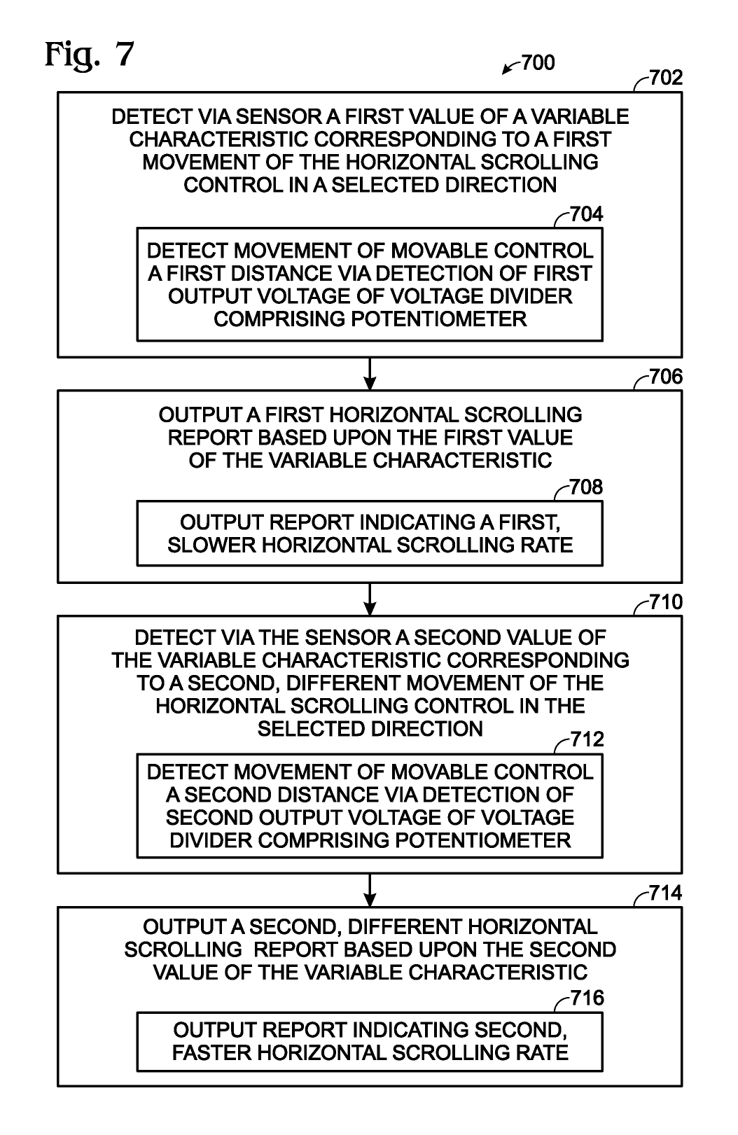

FIG. 7 shows a flow diagram illustrating a method 700 of generating horizontal scrolling reports in accordance with an embodiment of the present disclosure. It will be understood that method 700 may be implemented via a scroll wheel on a HID, or via any other suitable control on a HID.

Method 700 comprises, at 702 detecting via a sensor a first value of a variable characteristic corresponding to a first movement of a horizontal scrolling control (e.g. a tiltable scroll wheel) in a selected direction. The variable characteristic may comprise, for example, a location of the control along an axis of tilt rotation and/or a change in a location of the control, and the value may comprise one or more of a current location and a change in location as compared to a prior sample. In one embodiment, detecting at 702 may include, at 704, detecting movement of a movable control a first distance via detection of a first output voltage of a voltage divider comprising a potentiometer that outputs different voltages depending upon a location of the horizontal scrolling control.

Next, method 700 comprises outputting a first horizontal scrolling report based upon the first value of the variable characteristic. The horizontal scrolling report may include any suitable information, such as location data and change in location data (e.g., speed data). Outputting at 706 may include, at 708, outputting a horizontal scrolling report indicating a first, slower horizontal scrolling rate and/or a first rate of acceleration between horizontal scrolling rates.

Next, method 700 comprises, at 710, detecting via the sensor a second value of the variable characteristic corresponding to a second, different movement of the horizontal scrolling control in the selected direction. The second value may comprise a second current location that is different from the current location determined at 702, and/or a second change in location that is different from the change in location determined at 702. In one embodiment, detecting at 710 may include, at 712, detecting movement of the movable control a second distance via a second output voltage of the voltage divider comprising the potentiometer. The second distance may be relatively greater than the first distance, and may correspond to a larger tilt angle than the tilt angle associated with first movement.

Next, at 714 method 700 comprises outputting a second, different horizontal scrolling report based upon the second value of the variable characteristic. For example, outputting at 714 may include, at 716, outputting a horizontal scrolling report indicating a second, faster horizontal scrolling rate, and/or a different rate of acceleration between scrolling rates. In this manner, a horizontal scrolling control, such as a tiltable scroll wheel, may provide a finer degree of control than traditional tiltable scroll wheels, which may merely utilize a binary on/off scroll sensor for each direction of horizontal scrolling.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, human interface devices, mobile communication devices (e.g., smart phone), and/or other computing devices, including but not limited to the computing devices and human interface devices disclosed herein.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices. Storage machine 804 and logic machine 802 may in some embodiments be incorporated in controller on a human interface device.

It will be appreciated that storage machine 804 includes one or more physical devices. However, aspects of the instructions described herein alternatively may be propagated by a communication medium (e.g., an electromagnetic signal, an optical signal, etc.), as opposed to being stored via a storage medium.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 800 implemented to perform a particular function. In some cases, a program may be instantiated via logic machine 802 executing instructions held by storage machine 804. It will be understood that different programs may be instantiated from the same application, service, code block, object, library, routine, API, function, etc. Likewise, the same program may be instantiated by different applications, services, code blocks, objects, routines, APIs, functions, etc. The term program may encompass individual or groups of executable files, data files, libraries, drivers, scripts, database records, etc.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

Input subsystem 808 may comprise or interface with one or more user-input devices such as a keyboard, game controller, mouse, touch sensor, button, optical position tracker, etc. In some embodiments, the input subsystem may comprise or interface with selected natural user input (NUI) componentry. Such componentry may be integrated or peripheral, and the transduction and/or processing of input actions may be handled on- or off-board.

Communication subsystem 810 may be configured to communicatively couple computing system 800 with one or more other computing devices (e.g. to communicatively couple a human interface device to a host computing device). Communication subsystem 810 may include wired and/or wireless communication devices compatible with one or more different communication protocols.

It will be understood that the configurations and/or approaches described herein are presented for the purpose of example, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A human interface device comprising:
a horizontal scrolling control;
one or more sensors configured to sense movement of the horizontal scrolling control and provide output that varies depending upon a value of a variable characteristic of the movement; and
a controller configured to output horizontal scrolling reports having two or more different possible values for each direction of horizontal scrolling based upon the output of the one or more sensors.

2. The human interface device of claim 1, wherein the human interface device comprises a computer mouse.

3. The human interface device of claim 1, wherein the movable horizontal control comprises a tiltable scroll wheel.

4. The human interface device of claim 1, wherein the one or more sensors comprises a potentiometer.

5. The human interface device of claim 4, wherein the potentiometer is connected to the movable horizontal scrolling control via one or more of a lever and a gear mechanism.

6. The human interface device of claim 1, wherein the one or more sensors comprises one or more of a Hall Effect sensor, a pressure sensor, a force sensor, and a digital switch.

7. The human interface device of claim 1, further comprising an analog to digital converter configured to convert signals from the one or sensors into digital values, and wherein the controller is configured to receive the digital values from the analog to digital converter and to output horizontal scrolling reports based upon the digital values.

8. The human interface device of claim 7, wherein each horizontal scrolling report specifies a horizontal scrolling speed selected to which a corresponding digital value from the analog-to-digital converter is mapped.

9. The human interface device of claim 1, wherein the sensor comprises a potentiometer, and wherein the variable characteristic comprises one or more of location and change in location.

10. A computer mouse, comprising:
a scroll wheel having a rotational motion mechanism and a tilt motion mechanism;
one or more sensors configured to sense tilt of the scroll wheel and provide an output that depends upon a magnitude of the tilt;
an analog-to-digital converter configured to convert an output of each sensor to a digital value; and
a controller configured to sample an output of the analog-to-digital converter and to output a horizontal scrolling report based upon the sample.

11. The human interface device of claim 10, wherein the one or more sensors comprises a potentiometer.

12. The human interface device of claim 11, wherein the potentiometer is connected to the movable horizontal scrolling control via one or more of a lever and gear mechanism.

13. The human interface device of claim 10, wherein the one or more sensors comprises a Hall Effect sensor, a pressure sensor, a force sensor, and a digital switch.

14. The human interface device of claim 10, wherein the report comprises location data and also change in location data.

15. The human interface device of claim 10, wherein the horizontal scrolling report specifies a horizontal scrolling speed selected to which a corresponding digital value from the analog-to-digital converter is mapped.

16. A computer mouse, comprising:
a scroll wheel comprising a horizontal scrolling control;
a sensor configured to detect a first value of a variable characteristic corresponding to a first movement of the horizontal scrolling control in a selected direction, and to detect a second value of the variable characteristic corresponding to a second movement of the horizontal scrolling control in the selected direction; and
a controller configured to output a first horizontal scrolling report based upon the first value of the variable characteristic, and a second horizontal scrolling report based upon the second value of the variable characteristic.

17. The computer mouse of claim 16, wherein the first movement comprises movement of the horizontal scrolling control a first distance in the selected direction, and wherein the second movement comprises movement of the horizontal scrolling control a second distance in the selected direction.

18. The computer mouse of claim 16, wherein the first movement comprises a tilting of the scroll wheel a first amount,
wherein the second movement comprises a tilting of the scroll wheel a second, greater amount,
wherein the first horizontal scrolling report indicates a first, slower scrolling rate, and
wherein the second horizontal scrolling report indicates a second, faster scrolling rate.

19. The computer mouse of claim 16, wherein detection of the first value of the variable characteristic comprises detection of a first output voltage of a potentiometer, and wherein detection of the second value of the variable characteristic comprises detection of a second output voltage of the potentiometer.

20. The computer mouse of claim 16, wherein the variable characteristic comprises one or more of location and change in location.
